(19) United States
(12) Patent Application Publication
(10) Pub. No.: US 2009/0278014 A1
(43) Pub. Date: Nov. 12, 2009

(54) Overhead track system for roadways

(75) Inventors: Jim Allen, Wetumpka, AL (US); James Daniel Moseley, Prattville, AL (US)

Correspondence Address: PILLSBURY WINTHROP SHAW PITTMAN, LLP, P.O. BOX 10500, MCLEAN, VA, 22102, US

(73) Assignee: Jim Allen, Wetumpka, AL (US)

(21) Appl. No.: 12/149,662

(22) Filed: May 6, 2008

(51) Int. Cl. B66C 5/04

(52) U.S. Cl. 248/323

(57) ABSTRACT

Equipment for collecting information from vehicles moving through a lane on a roadway is positioned over the roadway using a track structure and a transfer device. The transfer device is adapted to mount and move the equipment between a first location and a second location along the track structure. A mounting structure, such as a gantry, may be used to support the track structure and/or equipment over the lanes on the roadway. A pulley system may be disposed in the track structure to move the transfer device. Also, a displacing device to raise the equipment relative to the track structure when the equipment is being moved along the track may be used. Alternatively, the transfer device may be mounted in an offset configuration to move the equipment between locations without the use of a displacing device.

### BACKGROUND

1. Field of Invention

The present invention is generally related to a system for mounting and maintaining equipment over roadways. More specifically, the present invention relates to a track system for positioning equipment in an overhead structure over a roadway.

2. Description of Related Art

Some conventional systems and methods for automated toll collection or data collection employ an elevated structure (such as a gantry or a truss structure), overpasses, bridges or other structures over a roadway to support signs and equipment. Such equipment may include lighting equipment, observation equipment, and/or tolling or data collection equipment. Such tolling or data collection equipment may include vehicle sensing devices, cameras, radiofrequency (RF) and other antennas, magnetic detectors, RFID transponders and/or other equipment. For time to time, such equipment may require maintenance, service, or replacement. Generally, the cost of maintenance and replacing structures and/or equipment is high and may be difficult to access.

Servicing equipment may be dangerous and costly for several reasons. In order to access the equipment mounted on the elevated structure, multiple lanes of traffic must generally be shut down, thus reducing the amount of money/tolls and or data that are collected. Shutting down lanes also disrupts vehicle traffic and may decrease the number of vehicles using the roadway (e.g., due to less available lanes and/or back-ups).

Also, when lanes are shut down the roadway is less safe. For example, workers may be required to walk on the gantry or truss to access such equipment above a lane, thus introducing a risk of injury to the worker (such as by falling). While working at an elevated level, there is a risk of dropping tools and/or equipment from the structure onto the roadway below. Also, vehicle traffic may be redirected from the lane(s) that are shut down to open lanes, thus increasing the risk to workers near the roadway (such as those on the shoulder or side of the road). Additionally, vehicles may be required to merge or switch lanes at substantial speed which also increases the risk on the roadways.

### SUMMARY

Various embodiments of the invention include a system for positioning or mounting equipment over a roadway. The equipment may be used to collect information from vehicles moving through one or more lanes on the roadway. The system includes a track structure and a transfer device. The transfer device is moveably disposed in the track structure. The transfer device may be used to move the equipment mounted thereto along the track structure so as to position the equipment near or above a lane in the roadway. The system provides assistance to the user when equipment requires maintenance, service, or replacement. The track structure and transfer device assist in providing easier access to the equipment and prevent shutting down lanes of the roadway. The system also assists in reducing potential injury to users and vehicle operators on the roadway and the time and cost associated with accessing equipment.

The transfer device may work in cooperation with a pulley system provided in the track structure to move the transfer device along the track structure.

In some embodiments, the track structure may include a plurality of tracks to hold a plurality of equipment over multiple lanes in the roadway. One or more tracks may house a conduit system for protecting cables and/or wiring.

In some embodiments, a mounting structure may be provided to support or hold the equipment over a lane or other feature of the roadway. The track structure may be mounted to or on a mounting structure such as a gantry. Equipment mounting braces may also be used to hold the equipment in relation to the roadway.

In some embodiments, a displacing device is provided in the track structure. The displacing device is used to raise or lower the equipment from a first position to a second position relative to the track structure. The displacing device enables the user to move one equipment along a track without damaging a second equipment on the same or a different track.

Other objects, features, and advantages of the invention will become apparent from the following detailed description, the accompanying drawings, and the appended claims.

### BRIEF DESCRIPTION OF THE DRAWINGS

FIG. 1 illustrates an overhead track system for roadways with equipment in accordance with various embodiments of the invention;

FIGS. 2a and 2b illustrate a side and front view, respectively, of the track system of FIG. 1;

FIG. 3 illustrates a detailed side view of an end of a track of the track system of FIG. 2;

FIGS. 4a and 4b illustrate cross-sectional side views of a track with electrical conduit, cables, and a pulley cord therein in accordance with various embodiments of the invention;

FIG. 5 illustrates a detailed, front view of transfer device for use with the track of FIGS. 2 and 3;

FIGS. 6a, 6b, and 6c illustrate a detailed cross sectional, front, and internal view, respectively, of an end cap on the end of the track of FIGS. 2 and 3;

FIG. 7a illustrates a cross-sectional side view of the track system for holding equipment in the end caps in accordance with various embodiments of the invention;

FIG. 7b illustrates a cross-sectional side view of the track system docked in the end cap of FIGS. 6a-6c in accordance with various embodiments of the invention;

FIG. 8 illustrates a side view of the positioning of equipment mounting braces for the equipment on the track system of FIG. 1 in accordance with various embodiments of the invention;

FIG. 9 illustrates a side view of the system of FIG. 1 wherein one of the equipment mounting braces is lifted for movement along a track in accordance with various embodiments of the invention;

FIG. 10a illustrates an overhead view of an end cap on a track with a displacing device in accordance with various embodiments of the invention;

FIG. 10b illustrates a side view of the displacing device of FIG. 10a in accordance with various embodiments of the invention;

FIGS. 11a-11c illustrate the use of the displacing device of FIGS. 10a and 10b to displace an equipment mounting brace and the equipment for movement along the track in accordance with various embodiments of the invention;

FIG. 12 illustrates an overhead track system for roadways with a track structure and equipment in accordance with various embodiments of the invention;

FIG. 13 illustrates an end or a side view of the track system of FIG. 12 including equipment in two locations in accordance with various embodiments of the invention;

FIG. 14 illustrates an overhead view of the track system of FIG. 12;

FIG. 15 illustrates a cross-sectional view as shown in FIG. 12 of an end of a track with wheels, equipment support, electrical conduit, cable, transfer pulley, and cords in accordance with various embodiments of the invention;

FIG. 16 illustrates a detailed view of a front of a distal end of the track showing an internal tracking system arrangement in accordance with various embodiments of the invention;

FIG. 17 illustrates a transfer device at a proximal end of the track structure of FIG. 12 in accordance with various embodiments of the invention;

FIGS. 18a and 18b illustrate a top and side view, respectfully, of a part of a transfer device of the track structure of FIG. 12 including associated pulleys, transfer cords, and tensioning devices in accordance with various embodiments of the present invention; and

FIGS. 19a and 19b illustrate a locking mechanism used with the transfer device of the track system of the FIG. 12 in a secured (closed) and unsecured (open) position, respectively, in accordance with various embodiments of the invention.

### DETAILED DESCRIPTION OF THE INVENTION

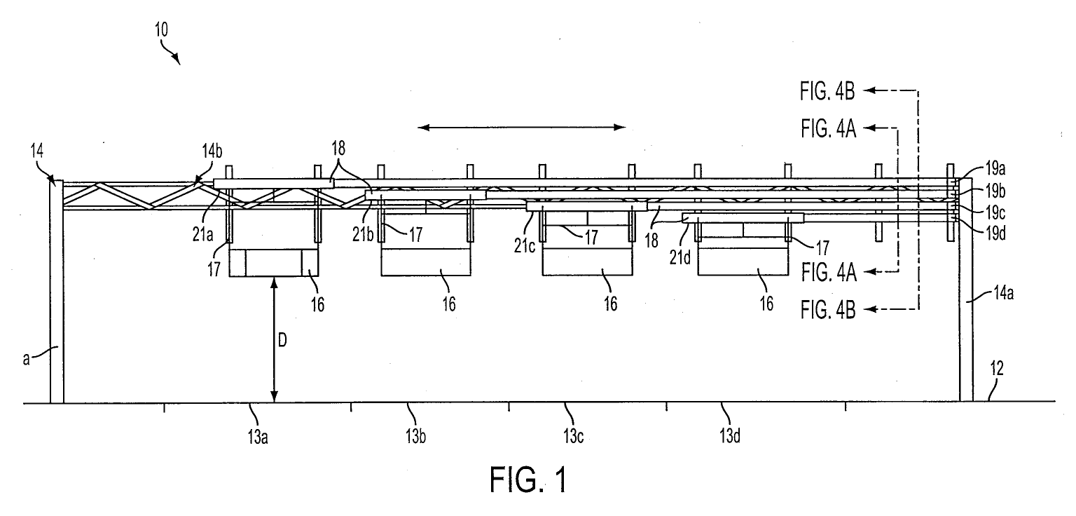

FIG. 1 illustrates an overhead track system 10 for roadways 12 with equipment 16 in accordance with various embodiments of the invention. Roadways 12 may include, for example, highways, expressways, toll roads, streets, local roads, exit roads, or other roads accessed by automobiles, trucks, tractor trailers, motorcycles, and other motorized vehicles.

As illustrated, track system 10 may include a mounting structure 14 and one or more equipment 16. Mounting structure 14 may hold at least one equipment 16 over roadway 12. Equipment 16 may collect information from vehicles moving on roadway 12. In some embodiments, the mounting structure 14 may be a gantry that holds at least one equipment 16 over a particular lane 13a-13d or other feature of roadway 12. When employed in tolling systems, for example, the mounting structure or gantry 14 may hold at least one equipment 16 so as to sense a vehicle moving through each of the lanes 13 in roadway 12. Roadway 12 may include any number of lanes 13 as would be apparent.

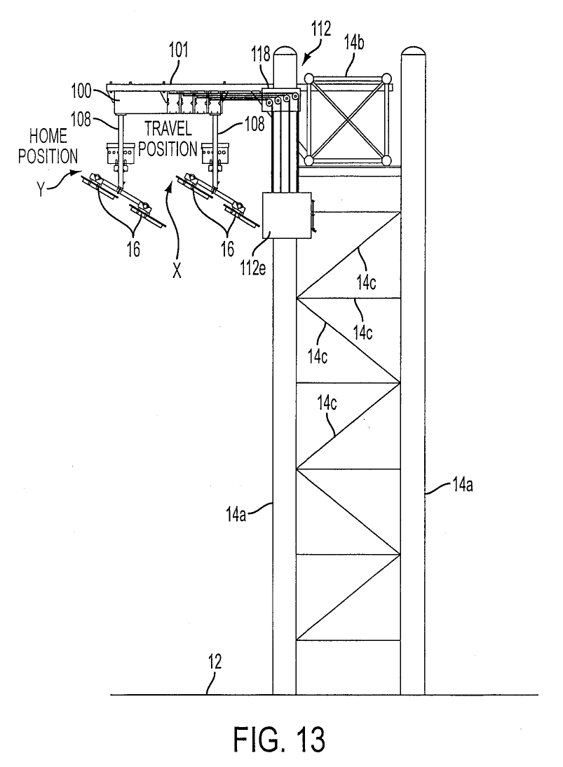

As illustrated in FIG. 1, gantry 14 may include side supports 14a and a plurality of overhead truss sections 14b or structures as would be apparent. Side supports 14a are provided alongside roadway 12 (e.g., on a shoulder of a roadway or, where pedestrians or workers may walk without risk) in the form of rods, poles, beams, or the like. Any number or type of side supports 14a may be used. For example, a plurality of side supports 14a may be provided or connected with a plurality of angled supports 14c (as shown, for example, in FIG. 13). Side supports 14a may hold truss sections 14b over the at least one lane 13 of roadway 12. In some embodiments of the invention, any number of truss sections 14b may be used in track system 10. Furthermore, truss sections 14b may include any number of members or structures. Generally, any design of a truss section or structure may be used with the gantry 14. For example, a truss, monopole, I-beam, box-beam, or any other structure may be used with gantry 14.

In some embodiments, gantry 14 need not be provided. For example, the mounting structure 14 may include a truss, beam, or other structure that may be mounted directly to a bridge or overpass that exists over a roadway. Generally, however, the track system 10, will be described with reference to the gantry 14 as illustrated in FIG. 1 for purposes of explanation.

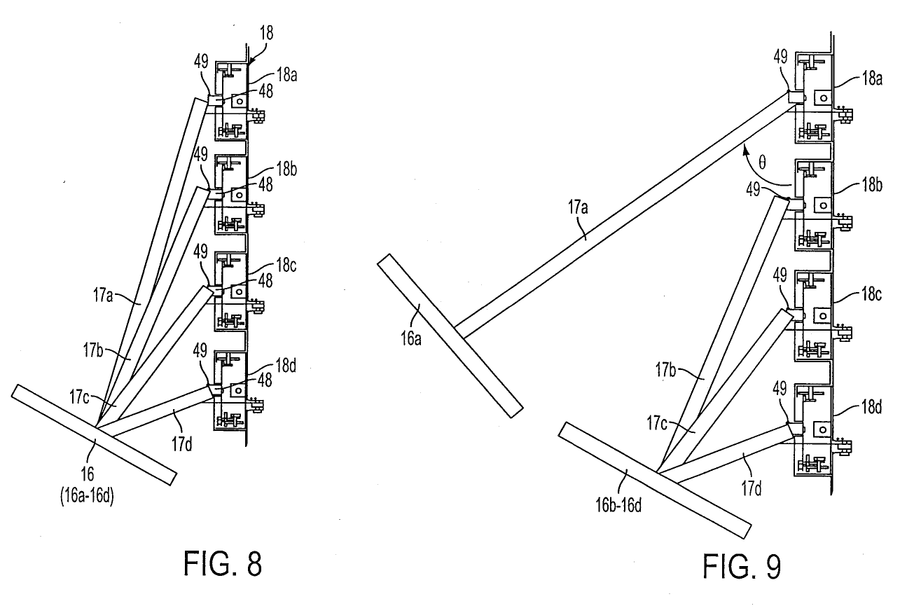

As noted above, track system 10 supports one or more equipment 16 over lanes 13 of roadway 12. In some embodiments of the invention, track system 10 may hold at least one component of equipment 16 over each lane 13 in roadway 12. Equipment 16 may be mounted to gantry 14 using equipment mounting braces 17 and a track structure 18. In some embodiments, the equipment mounting braces 17 may be mounted to a mounting structure 14 that is attached to an existing structure such as a bridge or overpass. Alternatively, in some embodiments, equipment mounting braces 17 may be attached or mounted directly to such existing structure(s). In some embodiments of the invention, equipment mounting braces 17 may hold equipment 16 such that equipment 16 are aligned with and above a lane 13 in roadway 12 at or near a first position or distance D above roadway 12. The first position or distance D may include, for example, a predetermined height and/or location. For example, the distance D may be determined according to Federal Highway standards. In some embodiments, the distance D may be between approximately 14 and approximately 27 feet. In an embodiment, the distance D may be approximately 17 feet. As illustrated in FIG. 8, in some embodiments, equipment mounting braces 17 may be pivotally attached via pivot connections 49 to the track structure 18 of mounting structure or gantry 14. The pivot connections 49 may assist in aligning at least one equipment 16 in first position or distance D above the roadway 12, for example.

The first position or distance D may include a position that is generally on the front of the mounting structure or gantry 14, such that the equipment 16 is held forward of the structure, for example. In some embodiments, the equipment 16 may be held or mounted rearward of the mounting structure 14, or alternatively, below the mounting structure 14.

In some embodiments of the invention, equipment mounting braces 17 may hold equipment 16 such that equipment 16 are aligned with and above an edge of lane 13 in roadway 12 or an edge of roadway 12 itself, again at or near a first position or distance D above roadway 12. In some embodiments of the invention, equipment mounting braces 17 may hold equipment 16 such that equipment 16 are positioned anywhere above roadway 12 at distances other than D above roadway 12.

In some embodiments of the invention, equipment 16 may include tolling equipment to assist in toll collection so as to collect an appropriate fare. In some embodiments of the invention, equipment 16 may detect a vehicle passing over roadway 12 and/or through lane 12 and collect additional information regarding the detected vehicle, such as a speed of the vehicle, a length of the vehicle, an axle count of the vehicle (e.g., 2 axle or 4 axle), and/or a chassis height of the vehicle, or other types of vehicle measurements and data, for example. In some embodiments of the invention, equipment 16 may include devices for determining a type of vehicle that uses roadway 12, a number of vehicles passing the location or point of the equipment 16 each day, or other types of roadway usage data In some embodiments of the invention, equipment 16 may include an RF antenna, RFID detector, or camera, or other sensing devices. In some embodiments of the invention, equipment 16 may include a camera that is positioned to take a photograph of a license plate of the vehicle. In some embodiments of the invention, various types of equipment 16 may be used for different purposes within track system 10. For example, equipment 16 may be used to data for collecting tolls/monies from vehicles or for collecting information related to homeland security, federal highway regulations, and others.

In some embodiments, equipment mounting braces 17 may work in cooperation with at least one track 18 of track system 10 to hold equipment 16 on mounting structure or gantry 14 above roadway 12. At least one track structure 18 may be attached to mounting structure 14, such that the track structure 18 may be used to position equipment in a desired position and/or location.

In some embodiments of the invention, such as when a plurality of equipment 16 is provided, a plurality of tracks 18 may be attached to the mounting structure 14. For example, a plurality of equipment 16 may be used with a roadway 12 such as a multiple-lane highway or speedway. As illustrated in FIG. 1, four equipment 16 and four tracks 18 may be provided on gantry 14 above a four-lane roadway 12. More specifically, each equipment 16 may be aligned above a respective one of four lanes 13a-13d of roadway 12. However, as previously noted, any number of tracks 18, equipment 16, or lanes 13 may be used. In addition, equipment 16 may be positioned along any point near or above roadway 12 (i.e., not just over a particular lane 13). Further, a single equipment 16 may be provided near or over roadway 12 independent of a number of lanes 13 in roadway 12.

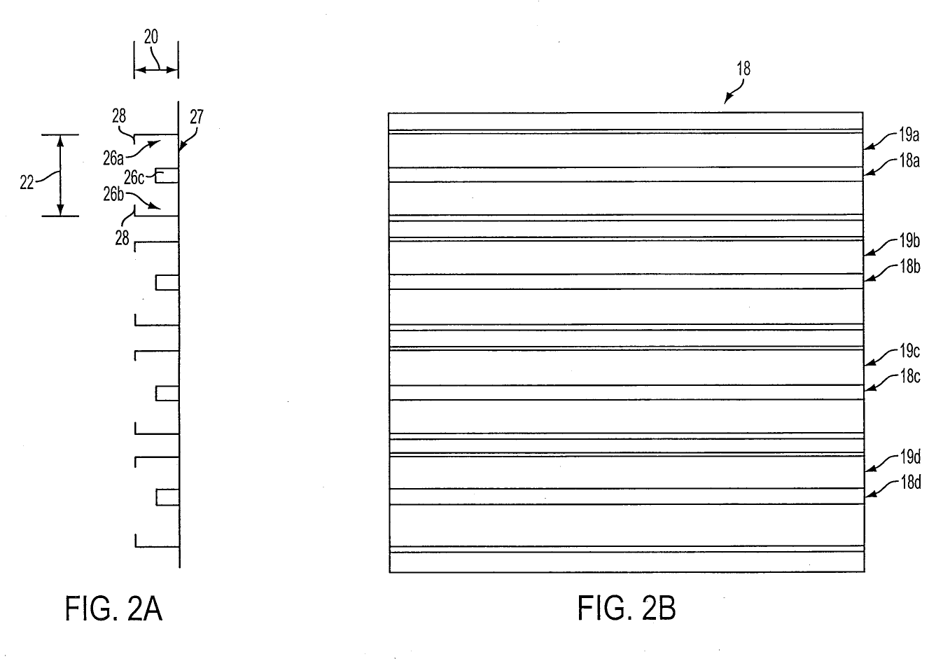

FIGS. 2a and 2b illustrate a side and front view, respectively, of track structure 18 for use with track system 10 of FIG. 1. Track structure 18 may be mounted to or on a mounting structure 14, for example. As will be further described, the track structure 18 may be used to position equipment 16 near or above roadway 12. The track structure 18 includes at least one track section. The track structure 18 may use a track section(s) of multiple sizes, shapes, or dimensions.

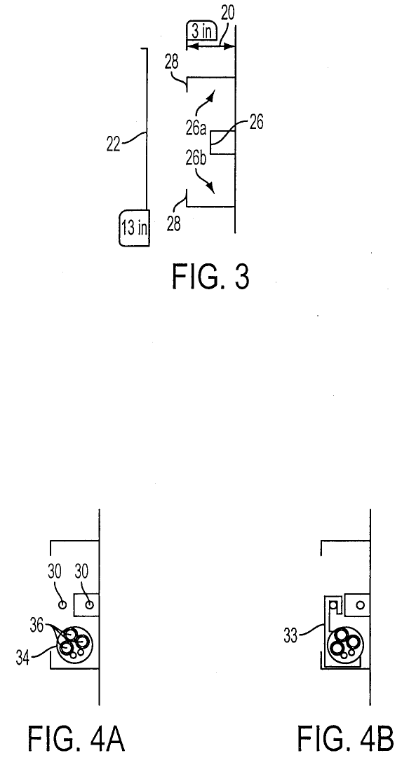

For illustrative purposes only, track structure 18 as illustrated in the Figures includes four (4) tracks 18a, 18b, 18c, and 18d. Track sections 18a-18d may be mounted or stacked on top one another on truss section 14b of gantry 14. In some embodiments of the invention, tracks 18a-18d may be mounted on a mounting structure 14 such as a truss, monopole, I-beam, box-beam, bridge or overpass, or any other structure, such that at least one equipment 16 may be positioned near or over a roadway. Each track section 18a-18d includes a proximal end 19 (illustrated as proximal ends 19a, 19b, 19c and 19d, respectively) and a distal end 21 (illustrated as distal ends 21a-21d, respectively) (see FIG. 1). Each track section 18a-18d includes a width or depth 20, a height 22, and a length (illustrated in greater detail in FIG. 3). In some embodiments of the invention, each track section 18a-18d may include a width 20 in the range of approximately 1 inch to approximately 8 inches deep. In some embodiments, width 20 may be approximately 3 inches (7.62 centimeters). In some embodiments of the invention, each track section 18a-18d may include a height 22 in the range of approximately 4 inches to 24 inches. In an embodiment, the height 22 may be approximately 13 inches (33.02 centimeters). In some embodiments of the invention, the length of each of track sections 18a-18d (i.e., the distance between the proximal end 19 and the distal end 21 of the respective track section), may be dependent upon a location of within roadway 12 for which an equipment 16 is to be positioned. In other words, the length for the location of distal ends 21a-21d of tracks sections 18a-18d on gantry 14 may be used as a method for determining the position of equipment 16 (e.g., for docking or mounting or servicing or installing).

Referring back to FIG. 1, for example, in some embodiments of the invention, a top track section 18a of track structure 18 may have a longer length than that of a bottom track section 18d, such that equipment 16 may be positioned over a left most position over roadway 12 (e.g., which may correspond to, for example, a first lane 13a). In some embodiments of the invention, track sections 18a-18d may be mounted in descending order according to their length. In some embodiments, track sections 18a-18d may be mounted in ascending order according to their length.

The above noted shapes, dimensions, or measurements of the track structure 18 or track sections 18a-18d, however, are not intended to be limiting. For example, the width 20, height 22, a length or shape of each track 18 may accommodate the weight or size of equipment 16, the size of the components of transfer device 40, and/or other factors.

The track structure 18 may be made of any number of materials, such as, but not limited to, aluminum, plastic, steel, carbon fiber, fiberglass, wood, metal, etc. The track structure 18 may be made using any number of processes as well, such as, but not limited hereto, molding, extrusion, forming, shaping, welding, etc.

For example, each track section 18a-18d of FIGS. 2 and 3 may include an upper and lower channel 26a and 26b, an extension portion 26c, a back portion 27, and front portions 28. Extension portion 26c may extend into the body of track sections 18a-18d and may assist in forming channels 26a and 26b, for example. However, the channels 26a and 26b and extension 26c may not be required. For example, the track sections 18a-18d may provide an opening or single channel (not illustrated) for accommodating devices such as those mentioned above. Additionally, in some embodiments, each of the track sections 18a-18d may include different shapes and designs. For example, a track section 18a may include an extruded design including an extension portion 26c and/or channels 26a and 26b, while track section 18b may include a single channel (not illustrated), etc.

As illustrated in FIGS. 4a and 4b, a conduit system may be provided within each track section 18a-18d for connecting to equipment 16, for example. In some embodiments, the conduit system may be provided in at least one of the track sections 18a-18d of the track structure 18 of FIG. 1. In some embodiments, the conduit system may be provided in a plurality of sections of the track structure 18. The conduit system may be used to assist in sealing, protecting, or capturing elements to be used with equipment 16, for example. Conduit system may include, for example, cables 30, flexible conduit 34, electrical wiring 36, or other conduit components. Cables 30 may be a part of a transfer device 40 for example. Wiring 36 may be used to provide power to equipment 16, signs, lights, and/or other devices that are mounted on or near track system 10 for example. Extension portions 26c and/or channels 26a or 26b may house cables 30 therein. Wiring 36 and conduits 34 may be provided in the channels 26a or 26b, for example. The location of wiring 36 and 34 should not be limiting. Front portions 28 may be in the form of flanges, for example, and may assist in holding and allowing transfer device 40 to move along the channels 26a and 26b of the track 18.

As illustrated in FIG. 4b, a securing device 33 may also be provided for cables 30, conduit 34, and/or other devices within track structure 18. Securing device 33 may surround and assist in securing or locking cables 30 and/or conduit 34 within one or more of the track sections 18a-18d. In other words, securing device 33 may assist in preventing cables 30, conduit 34, and/or other devices within a track section 18a-18d from falling out thereof, while still allowing for transferring or movement of the devices (e.g., movement of cables 30, a transfer device 40, etc.). Securing device 33 may be in the form of a clip or insert. Securing device 33 may be shaped similarly to a track section 18a-18d which it is placed in. In some embodiments of the invention, securing device 33 may include any number of materials, such as HDPE material, for example.

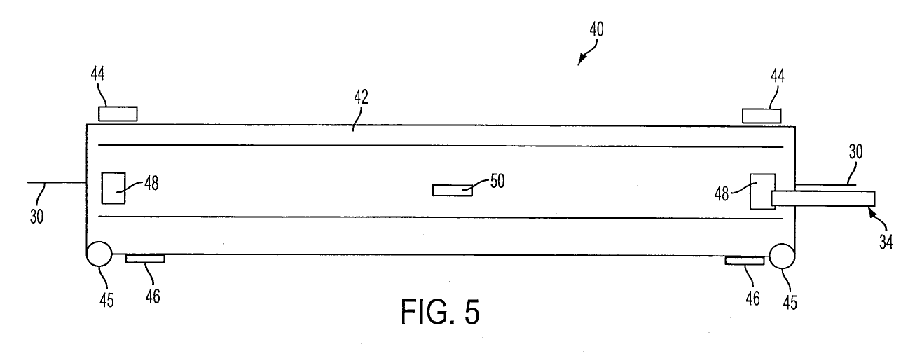

In addition to holding an equipment 16 over roadway 12 and/or lanes 13, in some embodiments, track 18 may also include a transfer device 40 (further described with respect to FIG. 5) therein to move or retract an equipment 16 between a first location and second location (e.g., along gantry 14). In other words, equipment 16 may be movably mounted (on gantry 14) such that, when needed, equipment 16 may be moved (e.g., by a worker) along the track 18 between the first location and the second location. In some embodiments of the invention, the first location may correspond to a location proximate the distal end 21 of a track section 18a-18d and the second location may correspond to a location proximate the proximal end 19 of the track section 18a-18d. For example, using track section 18c for illustrative purposes, equipment 16 may move along track section 18c using transfer device 40 from distal end 21c to proximal end 19c (and back again). In some embodiments, the transfer device 40 may move with or relative to the equipment 16 as it is moved. The transfer device 40 may also be used to adjust the positioning of one or more equipment 16 along the track structure 18. For example, should equipment 16 need to be directed from a first lane 13a to a third lane 13c, device 40 may assist in transferring such equipment to the needed location.

The ability to transfer or move equipment 16 along any of track sections 18a-18d of track structure 18 may provide access to equipment 16. In some embodiments, this access may be other than over the roadway or at least over a portion of the roadway not intended for vehicle traffic For example, when maintenance or replacement of an equipment is required, a worker may move equipment 16 from a first location (e.g., over a lane 13 in the roadway 12) to a second location (e.g., to the end of the truss section 14b, or towards side supports 14a, or an end of a mounting structure 14 along the side or shoulder of the roadway 12) to tend to the equipment. As will be described, one or more track sections 18a-18d may accommodate the cable 30 (see FIGS. 4a-4b) or other transfer mechanism of the transfer device 40 therein.

FIG. 5 illustrates a detailed, front view of a transfer device 40 which may be used with track structure 18 of FIGS. 2 and 3. Transfer device 40 may be used to transfer, move, and/or position equipment 16 along one or more track sections 18a-18d. For example, transfer device 40 may be used to move equipment 16 from a first location to a second location. Transfer device 40 may include a body 42, bearings or wheels 44, 45, and 46, mounting brackets 48, a pusher arm 50 and/or other components. Body 42 assists in transferring equipment 16. Body 42 works in cooperation with cable(s) 30 to transfer equipment 16. Body 42 may be mounted (directly or indirectly) to equipment 16. For example, equipment 16 may be attached to body 42 of the transfer device 40 by equipment mounting braces 17. In some embodiments, mounting brackets 48 may be provided. Mounting brackets 48 may be used in cooperation with equipment mounting braces 17 to hold equipment 16, for example. In other words, equipment mounting braces 17 may be attached to mounting brackets 48 to hold equipment 16 relative to body 42 of transfer device 40. Although two mounting brackets 48 are illustrated, any number of mounting brackets or mounting devices to hold equipment 16 on or in relation to body 42 of transfer device 40 may be used.

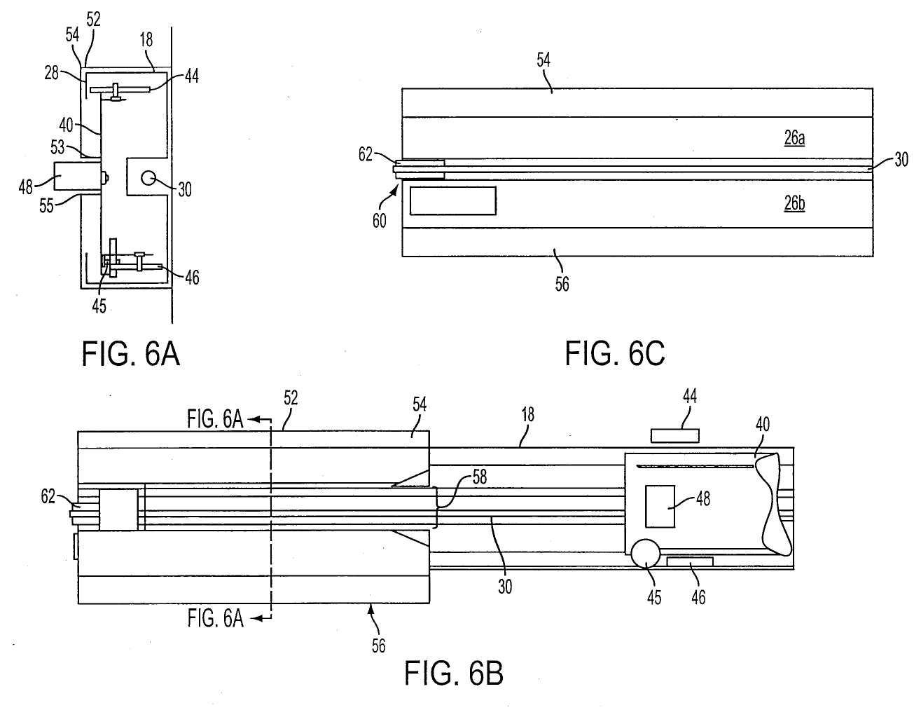

Bearings 44, 45, and 46 may also be provided on body 42 to assist in moving transfer device 40 within track sections 18a-18d. For example, bearings 44, 45, and/or 46 may be provided in channels 26a and 26b (e.g., see FIG. 6a). Bearings 44 may be provided to roll or move within channel 26a and bearings 46 may be provided to roll or move within channel 26b. Bearings 45 may be provided to roll on the bottom of the track section 18a-18d, such as on the bottom of channel 26b, for example, to further assist in moving and supporting the transfer device 40. Each bearing may move along with respect to front portion 28 and back portion 27 of the channels 26a, 26b, respectively. In some embodiments of the invention, bearings 44, 45 and/or 46 may be roller bearings, ball bearings, wheels, or other types of bearings. In some embodiments of the invention, wheels or other known mechanisms that move, slide or rotate may be used as bearings 44, 45, and 46 to move transfer device 40 along track structure 18.

As previously noted, transfer device 40 may include a shape and/or dimensions (e.g., width and height) that may fit within track structure 18. For example, the transfer device 40 may cooperate with channels 26a and 26b of one or more track sections 18a-18d. The length of transfer device 40 may accommodate the length of equipment 16 to be mounted above roadway 12. For example, the length of body 42 or transfer device 40 may accommodate the dimensions or weight of the equipment 16.

FIG. 5 illustrates a transfer cable or pulley cord 30 that may be attached to transfer device 40. Cable 30 may be used to assist in moving transfer device 40 (i.e., in moving equipment 16) along the track structure 18. Cable 30 may be attached to the body 42 of transfer device 40. For example, cable 30 may be secured to a first end and a second end of the body 42. Cable 30 may also be secured or attached to the back of body 42, for example. Cable 30 may work in cooperation with a pulley system 60, for example. The operation of cable 30 is further described below with reference to pulley system 60, as illustrated in FIG. 6c.

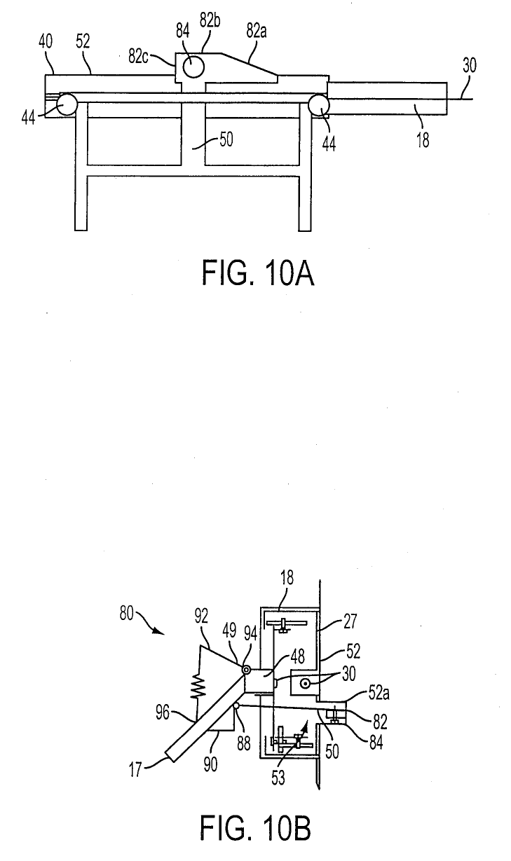

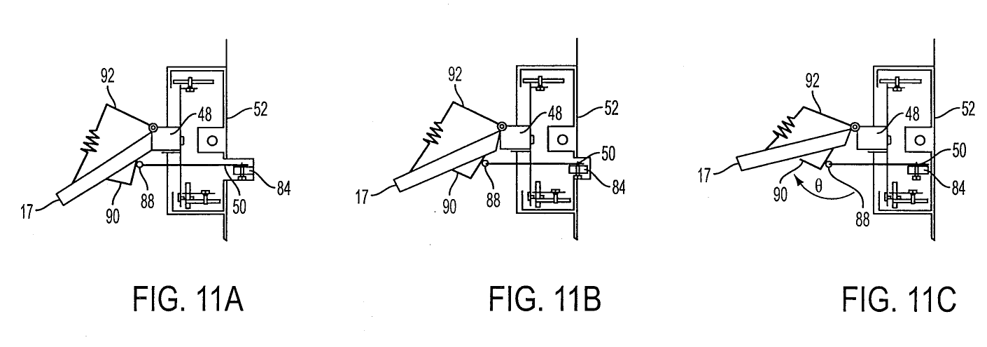

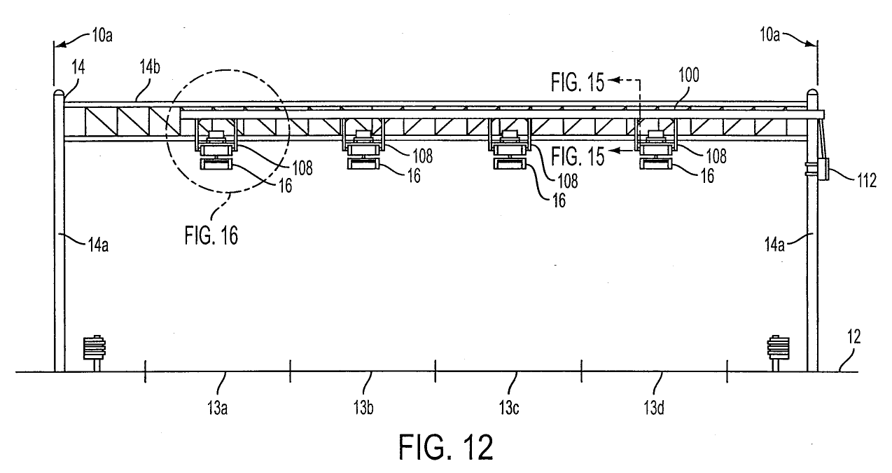

Also illustrated in FIG. 5 is a cross sectional view of a pusher arm 50. A side view of pusher arm 50 is illustrated in FIG. 10b. In some embodiments, pusher arm 50 may be a part of displacing device 80 (illustrated in FIGS. 10-10b and 11a-11c). Pusher arm 50 may be provided to assist in displacing equipment 16 when transfer device 40 is activated to move equipment between a first location and a second location along gantry 14, as will be described in FIGS. 10a-10b and 11a-11c.

FIGS. 6a, 6b, and 6c illustrate a detailed cross sectional, front, and internal view, respectively, of an end cap 52. End cap 52 may be provided on the end of one or more track sections 18a-18d used in track structure 18. For example, end cap 52 may be provided at a distal end 21a-21d of the track sections 18a-18d. Due to the weight of equipment 16, for example, track section 18a-18d alone may not be supportive enough to rigidly hold the transfer device 40 and/or equipment 16 at a select location. End cap 52 may thus assist in docking or mounting equipment 16 along a track structure 18 at a select or predetermined location (e.g., above a lane 13) in a semi-permanent manner.

End cap 52 may include a top flange 54 and a bottom flange 56. Top flange 54 and bottom flange 56 may hold and semi-permanently lock transfer device 40 in the selected or predetermined position along one or more of track sections 18a-18d (e.g., at a distal end 21 of a track). A channel 58 may be formed between top flange 54 and bottom flange 56. Channel 58 provides an area for receiving mounting brackets 48 of transfer device 40 such that flanges 54, 56 may capture or encapsulate transfer device 40 within one of track sections 18a-18d or behind the end cap 52.

FIG. 6a illustrates a cross sectional view of one of track sections 18a-18d and end cap 52 with transfer device 40 captured therein. End cap 52 may surround an entire track section 18a-18d including the back and front portions 27, 28. When transfer device 40 is positioned within end cap 52, mounting bracket(s) 48 may be guided into channel 58 such that each mounting bracket 48 may be positioned between the walls 53, 55 formed by top and bottom flanges 54, 56. Walls 53, 55, however, need not be provided. Mounting bracket(s) 48 may then be captured and braced in channel 58 between flanges 54, 56; thus, transfer device 40 may be braced, to rest therebetween. In some embodiments of the invention, at least one end of transfer device 40 may be positioned to be encapsulated within end cap 52. In some embodiments of the invention, at least one mounting bracket 48 of transfer device 40 may be held between channel 58 of end cap 52. In some embodiments of the invention, channel 58 may include a funnel or taper such that, as transfer device 40 moves into end cap 52, the channel area for equipment mounting braces 17 gradually tightens around the braces 17 to assist in docking or locking the equipment 16 therein.

FIG. 6c further illustrates an internal view of the inside of end cap 52 and one of track sections 18a-18d. As illustrated, end cap 52 may surround the respective track section 18a-18d such that channels 26a and 26b remain open to accommodate transfer device 40 when moved therein. Also illustrated is an end of a pulley system 60. Pulley system 60 may assist in transferring equipment 16 along track structure 18 using transfer device 40, for example. Pulley system 60 may include at least a wheel 62 and pulley cord or cable 30. Pulley system 62 may include a wheel 62 at proximal end 19 and distal end 21 of each track section 18a-18d, for example. FIG. 6c illustrates one of the wheels 62 provided at the distal end 21 of a track section 18a-18d, for example. Cable 30 may include a loop for surrounding the wheels 62. In some embodiments, such as illustrated in FIG. 4a, cable 30 may be positioned such that at least part of cable 30 is looped through extension part 26c of a track section 18a-18d. Cable 30 may be attached to the ends or back of body 42 of transfer device 40, for example. When it is desirable to move equipment 16, cable 30 of pulley system 60 may be moved (e.g., pushed or pulled) such that cable 30 travels around wheels 60 and moves transfer device 40 therewith.

In some embodiments, pulley system 60 may be manually activated. For example, a user or worker may manually grasp cable 30 to move cable 30 and thus transfer device 40 and equipment 16. In some embodiments, pulley system 60 may be actuated by a device. For example, movement of cable 30 and/or wheels 62 of pulley system 60 may be activated by a switch, an electromechanical actuator, a motor, or other powered or actuatable device.

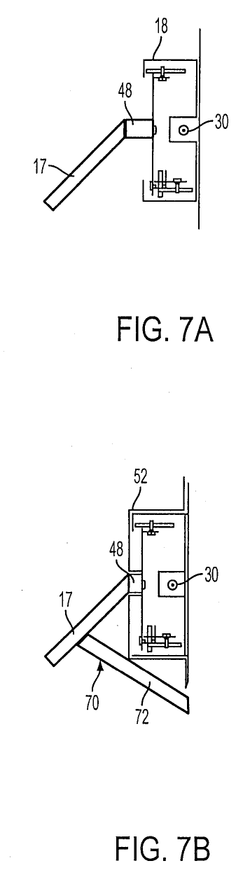

FIG. 7a illustrates a cross-sectional side view of track structure 18 with cable 30, transfer device 40, equipment mounting brace 17 and mounting bracket 48 in accordance with various embodiments of the invention. FIG. 7b illustrates a cross-sectional side view of track structure 18 with the above-listed elements of FIG. 7a docked in end cap 52 of FIGS. 6a-6c in accordance with various embodiments of the invention. In some embodiments of the invention, end cap 52 may be provided with a brace system 70 for assisting in docking the equipment mounting braces 17 and mounting brackets 48 at the distal end 21 of one or more track sections 18a-18d as illustrated in FIG. 7b. Brace system 70 may include a brace 72 for aligning with equipment mounting brace 17 and providing additional support and/or strength for holding equipment mounting brace 17 of equipment 16 in a predetermined location. In some embodiments, brace 72 may be permanently affixed to mounting structure or gantry 14. Brace 72 may be provided at an end (e.g., distal end 21) of track structure 18 or proximal an area along track structure 18 where equipment 16 will be positioned. In some embodiments, brace 72 may be retractably affixed to mounting structure or gantry 14. For example, brace 72 may be provided with an end which moves or pivots with respect to the mounting structure 14, such that brace 72 is aligned with equipment mounting bracket 17 or like only upon docking in end cap 52. In some embodiments, brace 72 may include an opening (not illustrated) for receiving a locking element (not illustrated) from equipment mounting bracket 17 therein. In some embodiments of the invention, brace system 70 or brace 72 may include a funnel or taper such that as transfer device 40 moves into end cap 52, brace system 70 or brace 72 may gradually tighten with respect to equipment mounting braces 17 to assist in docking or locking the equipment 16 therein.

FIG. 8 illustrates a side view of the positioning of the equipment mounting braces 17 for equipment 16 in end caps 52 on track system 10 of FIG. 1. As previously noted, the equipment mounting braces 17 may hold and align each of equipment 16a-16d above roadway 12 and at or near a similar first position or distance D above roadway 12. Thus, track sections 18a-18d are stacked atop each other on gantry 14. Because the distance D for hanging the equipment 16a-16d is substantially equal, the equipment mounting braces 17 must accommodate the required distance. The dimensions (e.g., length) of the equipment mounting braces 17a-17d thus depend upon the location of the respective track sections (e.g., track 18a, 18b, etc.) above roadway 12. For example, the higher a particular track section is placed in the stack, the longer the mounting brace 17 will need to be to allow for proper positioning of equipment 16 associated with that track section at distance D above the roadway 12. Thus, as illustrated in FIG. 8, a plurality of equipment mounting braces 17a, 17b, 17c, and 17d comprising different lengths are provided to position equipment 16 at the same or similar height or distance D above roadway 12. For example, because track section 18a is provided at the highest location on the gantry 14, the equipment mounting brace 17a has a greater length as compared to the equipment mounting brace 17d for track section 18d. Additionally, in order to accommodate the position or angle at which equipment 16a-16d must be positioned above roadway 12, each of the equipment mounting braces 17a-17d may be provided at a different angle with respect to their corresponding track section 18a-18d. In some embodiments of the invention, the distance D will be substantially similar for equipment (e.g., RF antennas, cameras, etc.) of the same type.

As previously mentioned, in some embodiments of the invention, the mounting braces 17 may be attached to the track sections 18a-18d using a pivot connection 49. In some embodiments, the mounting braces 17 may be attached to mounting bracket(s) 48 of transfer device 40 via pivot connections 49. Pivot connection 49 may assist in positioning equipment 16 at first position or distance D.

The track system 10 as described above in FIGS. 1-8 may assist a user or worker when equipment 16 such as tolling or data collection equipment, camera, antennas, and other devices require maintenance, service or replacement. Various embodiments of the invention may reduce the cost of maintenance. For example, when replacing or changing broken equipment, the amount of time required for shutting down lanes may be decreased. Additionally, various embodiments of the invention may allow for easier access to the equipment mounted on the mounting structure or gantry, reduce the risk of injury to workers, reduce the risk of injury to vehicle operators, and/or reduce the amount time required to service the equipment.

Although the figures and description herein describe track system 10 for holding at least equipment 16 such as tolling or data collection equipment, cameras, antennas, etc., over roadway 12, track system 10 may also be used to hold traffic signs, messaging signs (such as digital messaging signs for alerting drivers of congestion, accidents, alerts, etc.), lights, or other known devices for hanging overhead lane(s). Similarly, devices that are hung above the lane(s) may also be mounted to move with the track structure 18.

Equipment 16 that is hung on the overhead track system 10 or structure 18 need not be the same device(s). For example, equipment 16 such as cameras may be provided over first and second lanes 13a and/or 13b, while equipment 16 such as antennas may be provided over third and fourth lanes 13c and/or 13d of a roadway 12.

Also, while illustrated in the Figures and described above as having different lengths, some embodiments of the invention may utilize a plurality of track sections 18a-18d in the track structure 18 of the track system 10 having a similar length, i.e., the tracks 18a-18d may extend the entire length of mounting structure or gantry 14 and/or truss sections 14b, from one side support 14a to another side support rod 14a on the opposite side of the roadway 12. In some embodiments, track sections 18a-18d may span the entire length of the lanes 13 in roadway 12 (e.g., such as when attached to a mounting structure 14 on a bridge or overpass). In order to position and dock or mount equipment 16, therefore, an end cap 52 may be positioned along one or more track sections 18a-18d at a location proximal to a desired position above roadway 12 (e.g., above a lane 13) and mounted to track section 18a-18d so as to limit or prevent the movement of equipment past the designated location of end cap 52. Further, brace 72 of brace system 70 may also be positioned proximal a desired area along track structure 18 (e.g., above a lane 13) where equipment 16 will be positioned to assist in holding equipment 16 and equipment mounting bracket 17 in a desired location. In some embodiments, one or more equipment 16 may be provided using a single track structure 18.

In some embodiments where a plurality of track sections 18a-18d are provided in track system 10, it may be important to hang equipment 16 at a same or similar height or distance D above roadway 12 for moving vehicles. In such embodiments, because equipment 16 are mounted or hung at substantially the same first position or distance D and/or angle, it may be difficult to transfer a particular equipment 16 from a distal end 21 to its proximal end 19 (alongside the roadway 12), as one or more of equipment 16a-16c may not be transferred without hitting or damaging one or more of other equipment closer to proximal end 19. In some embodiments of the invention, a clearance may be established to transfer equipment 16 so that they do not sustain damage.

FIG. 9 illustrates a side view of track system 10 with track sections 18-18d and equipment mounting braces 17a-17d, wherein equipment mounting brace 17a is lifted for movement along its track section 18a so as to facilitate movement of the equipment 16a to its proximal end 19a near the side supports 14a along the side of roadway 12. By displacing or raising equipment mounting braces 17, the risk of damaging other equipment 16 may be avoided. For example, equipment mounting brace 17a may be moved, displaced, or raised at an angle Θ from track structure 18 using at least pivot connection 49. In some embodiments of the invention, the angle Θ includes a distance for a clearing at least the top of equipment 16b-16d. In some embodiments of the invention, the angle Θ may include a range of approximately 10 degrees to approximately 130 degrees.

In order to lift or displace equipment 16, a system or device may be provided near or proximate to end cap 52 of track structure 18 before moving equipment 16. FIG. 10a illustrates an overhead view of end cap 52 on one of track sections 18a-18d with displacing device 80 in accordance with various embodiments of the invention. Displacing device 80 may work in cooperation with pivot connection 49, for example. Transfer device 40 and thus equipment mounting brace 17 may be docked in end cap 52 on track section 18a-18d. FIG. 10b illustrates a side view of docked equipment 16. FIGS. 10a and 10b also illustrate pusher arm 50 of transfer device 40 in greater detail.

As previously noted with respect to FIG. 5, pusher arm 50 may be provided with displacing device 80 to assist in raising or displacing equipment 16 when transfer device 40 is activated to move equipment 16 between a first location and a second location along the mounting structure or gantry 14. Pusher arm 50 may work cooperatively with equipment mounting brace 17 of equipment 16. For example, an end 88 of the pusher arm 50 may be connected to part of the equipment mounting brace 17. In some embodiments of the invention, end 88 of pusher arm 50 may be moveably connected equipment brace 17. In some embodiments of the invention, end 88 may include a bearing such as a roller bearing, a ball bearing, or other bearing. In some embodiments of the invention, equipment mounting brace 17 may include an angled structure 90 for pusher arm 50 to work in cooperation therewith. For example, end 88 of pusher arm 50 may move along a wall of angled structure 90.

Pusher arm 50 may also include a guide wheel 84 at an opposite end thereof. Guide wheel 84 may be provided to assist in positioning equipment 16 along track section 18a-18d, as will be explained below. The dimensions of the pusher arm 50 may depend upon the track location. For example, the higher a track is placed in the stack, the shorter the pusher arm 50 may need to be to allow for proper positioning at distance D and/or angle above roadway 12. Pusher arm 50 may be shorter for higher track sections 18a-18d because the angle at which the equipment mounting brace 17a and pivot connection 49 must be positioned for equipment 16a, for example, must be lower or smaller that the angle at which the equipment mounting brace 17d and pivot connection 49 is provided for equipment 16d.

The dimensions and/or location of angled structure 90 with respect to equipment mounting brace 17 may depend upon the location of track section (e.g., track section 18a, 18b, etc.). For example, as noted, the higher a track section 18a-18d is placed in the stack, the longer the mounting brace 17 will need to be. Structure 90, therefore, may need to be positioned relative to the brace 17, such that displacing device 80 is capable of applying a displacing force in the proper location to lift or lower equipment 16.

FIG. 10a also illustrates various embodiments of the invention wherein end cap 52 includes a chamber 82. As illustrated in FIG. 10b, when chamber 82 is provided on end cap 52, back wall 27 of the track structure 18 may include an opening 53 for accommodating chamber 82 therein. Chamber 82 may receive guide wheel 84 and pusher arm 50 therein. In some embodiments of the invention, chamber 82 may include a sloped surface or wall 82a, a back wall 82b, and a stop wall 82c. As will be further described with FIGS. 11a-11c, guide wheel 84 on pusher arm 50 may travel along sloped wall 82a and onto back wall 82b. Thus, pusher arm 50 may also extend back into chamber 82. Stop wall 82c may stop guide wheel 84 and pusher arm 50 from further movement.

Displacing device 80 may also further include a resilient mechanism 92. Resilient mechanism 92 may be attached using ends 94, 96 at or near the pivot point of equipment mounting brace 17 and mounting bracket 48. In some embodiments of the invention, an end 94 of resilient mechanism 92 may be attached to mounting bracket 48. In some embodiments of the invention, end 94 of resilient mechanism 92 may be connected to pivot mechanism 49. In some embodiments of the invention, an end 96 of resilient mechanism 92 may be attached to equipment mounting brace 17. Resilient mechanism 92 may act as a counterbalance to equipment mounting brace 17. Resilient mechanism 92 may also aid in displacing the equipment mounting brace 17 and equipment 16 into a raised (or lowered) position. In some embodiments of the invention, end 96 of resilient mechanism 92 may move with respect to brace 17 during positioning of equipment 16. Resilient mechanism 92 may include a spring, for example. The type of resilient mechanism 92 used may depend on the weight of equipment 16 or equipment mounted on the equipment mounting brace, and/or the dimensions (e.g., length, width) of the equipment mounting brace 17.

FIGS. 11a-11c illustrate the use of displacing device 80 to position (e.g., lift and dock) equipment mounting brace 17 and equipment 16 for movement along track sections 18a-18d in accordance with various embodiments of the invention. For example, when maintenance or service is required for equipment 16 positioned over roadway 12, a user may use pulley system 60 to move transfer device 40 along track structure 18. As the user does such, displacing device 80 may be activated. More specifically, resilient mechanism 92 may be activated to begin displacing the mounting brace 17 of equipment 16, as illustrated in FIG. 11a. As transfer device 40 moves out of end cap 52 (i.e., toward proximal end 19 of track section 18a), guide wheel 84 on pusher arm 50 may move along wall 82b, for example. As illustrated in FIG. 11b, as guide wheel 84 moves along sloped wall 82a, end 88 of pusher arm 50 moves along angled structure 90 on equipment mounting structure 17, thus continuing to raise equipment 16. FIG. 11c illustrates equipment 16 at its second position wherein pusher arm 50 has fully lifted equipment 16, and transfer device 40 and its guide wheel 84 are guided in along track structure 18.

In some embodiments, when positioning equipment 16 over a roadway 12 (i.e. the transfer device 40 is used to move equipment 16 from the proximal end 19 toward the distal end 21), for example, equipment mounting brace 17 may travel via transfer device 40 into end cap 52 and along walls 82a-82c of chamber 82. During transfer equipment 16 may be provided at a second position with respect to its track section 18a-18d. For example, as transfer device 40 is moving into end cap 52, equipment 16 may be provided at a raised or elevated level. Guide wheel 84 may be directed from end cap 52 to drop down sloped wall 82a and along back wall 82b and into a final position against wall 82c. Thus, mounting brace 17 may drop therein, and equipment 16 may be moved from the second position (i.e., raised position) to a first position (i.e., lowered position) with respect to track section 18a-18d. That is, equipment 16 may pivot via pivot connection 49 and into the predetermined distance D and position or angle.

Displacing device 80 may be generally activated upon activation of the pulley system 60. Displacing device 80, as illustrated, may use mechanical devices to elevate or lift the equipment mounting bracket 17 and thus the equipment 16 for transfer along track structure 18. However, displacing device 80 should not limited to the mechanical elements as illustrated and described. For example, displacing device 80 may also include an electromechanical actuator, a motor, or other powered or actuatable device for moving or raising equipment 16. In some embodiments, the dimensions and features of displacing device 80 may need to be altered according to the track location (e.g., depending on which track section 18a-18d it is mounted thereto) or according to equipment 16 mounted on equipment mounting brace 17. For example, the length of the equipment mounting bracket 17 and/or weight and/or amount of equipment 16 that is provided on track structure 18 may alter the dimensions, features, and/or type of displacing device 80.

In some embodiments, displacing device 80 may be used to move or displace equipment 16 in relation to the track structure 18 such that a first equipment 16 does not damage a second equipment on the same track 18 when moved therealong. For example, the track structure 18 may comprise multiple channels for receiving a plurality of transfer devices 40 therein, thus enabling a user to mount and position a plurality of equipment 16 over the roadway using a single track structure 18 with multiple channels, for example.

FIG. 12 illustrates an overhead track system 10a for roadways 12 with a track structure 100 and equipment 16 in accordance with various embodiments of the invention. Overhead track system 10a comprises similar elements as the track system 10 shown in FIG. 1; therefore, the description of such elements (though briefly noted below) as provided in paragraphs [0032]-[0039] are herein incorporated by reference in their entirety. For example, track system 10a of FIG. 12 may include a mounting structure 14 and one or more equipment 16 for collecting information from vehicles moving along roadway 12 in one or more designated lanes 13a-13d. Mounting structure 14 or gantry may comprise side supports 14a and overhead truss sections 14b or structures, as generally shown in FIG. 12.

In some embodiments, track system 10a may hold at least one component of equipment 16 over each lane 13 of roadway 12 by mounting equipment 16 to gantry 14 using mounting braces 108 and track structure 100. Like mounting braces 17, mounting braces 108 may hold equipment 16 in alignment with and above a lane 13a-13d in roadway 12 at or near a first position or distance D above roadway 12. Distance D may include any of the embodiments noted above with respect to FIG. 1. In some embodiments, mounting braces 108 may be mounted to a mounting structure 14 that is attached to an existing structure such as a bridge or overpass, or, alternatively, braces 108 may be mounted directly to an existing structure. Mounting braces 108 are used to hold equipment 16 at a first position or distance D above and that is generally in front of the mounting structure or gantry 14, such that the equipment 16 is held forward of the structure, or, alternatively, rearward or directly below the structure 14. Generally, equipment 16 may be aligned as described above with respect to track system 10. Additionally, equipment 16 may comprise tolling equipment, cameras, sensing devices, or other devices as noted above.

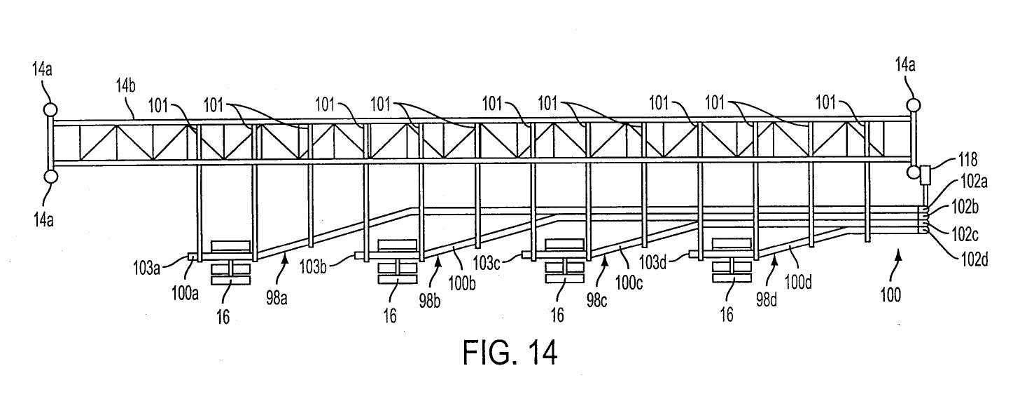

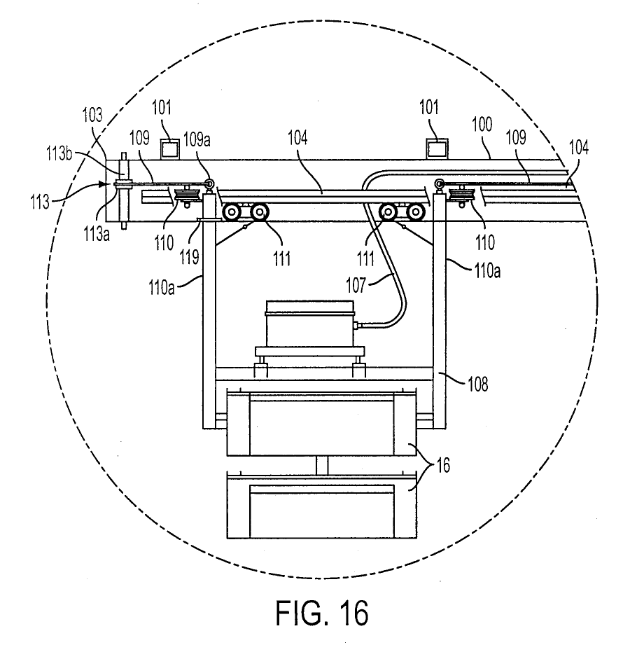

In some embodiments, mounting braces 108 may work in cooperation with track structure 100 of track system 10a to hold equipment 16 above roadway 12. Track structure 100 may comprise at least one track and may be attached to mounting structure 14 or gantry, such that the track structure 100 may be used to position equipment in a desired position and/or location. In some embodiments of the invention, track structure 100 may comprise a plurality of track sections 100a-100d, such that a plurality of equipment 16 may be used with roadway 12 comprising a number of lanes 13. As illustrated and further described with respect to FIG. 14, track structure 100 may include any number of tracks so as to position equipment 16 over lanes 13. Additionally, track structure 100 may comprise a transfer device 112 (described below with respect to FIGS. 13 and FIGS. 15-18) for holding and/or positioning equipment in, on, or within tracks 100a-100d near or above roadway 12. In addition to holding of equipment 16 over roadway 12 and/or lanes 13, transfer device 112 (illustrated in FIG. 16) moves or retracts equipment 16 between a first location X and a second location Y along gantry 14. That is, equipment 16 is movable in track structure 100 (supported by structure members 101) and mounted on gantry 14 such that when needed, equipment 16 may be moved (e.g., by a worker) along the track structure 100 between first location X and second location Y. In some embodiments of the invention, the second location corresponds to a location proximate to the proximal end 102 of track sections 100a-100d. For example, using track section 100a for illustrative purposes, equipment 16 or transfer device 112 may be designed to move along track section 100a from distal end 103a to proximal end 102a and back again.

The ability to transfer or move equipment 16 along any of track sections 100a-100d of track structure 100 is beneficial in that it allows for one to easily access equipment 16 for servicing. In some embodiments, this access may be other than over roadway 12, or at least over a portion of roadway 12 not intended for vehicle traffic. For example, when maintenance or replacement of equipment 16 is required, a worker may move equipment 16 from a first position X (e.g. over a lane 13 in the roadway 12) to a second position Y (e.g. to the end of the truss section 14b or towards side supports 14a along the side or shoulder of the roadway 12) to tend to equipment 16.

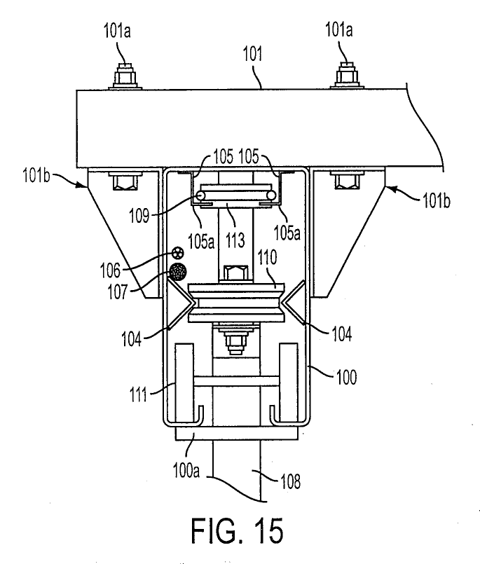

For example, FIG. 13 illustrates an end view of the track system 10a of FIG. 12 including equipment 16 in two locations. Generally, and as will be further described, a transfer device 112 is used with track structure 100 of the system 10a to transfer, move, and/or position equipment 16 along one or more track sections 100a-100d. For example, transfer device 112 may be used to move equipment 16 between a first location X (e.g., over a lane 13 in roadway 12) to a second location Y (e.g., to an end 102 of a track section 100a-100d, or towards side supports 14a, or an end of mounting structure 14 along the side or shoulder of roadway 12), such as described above with respect to transfer device 40 of system 10. Additional details with respect to transfer device 112 are described below in FIGS. 15-19.

Track structure 100 may comprise a plurality of track sections 100a-100d and a horizontal extension support 101. Track sections 100a-100d may be mounted to at least one horizontal extension support 101 using fasteners 101a or other devices, for example. Horizontal extension supports 101 extends horizontally from gantry 14 so as to position equipment 16 above the roadway 12 and allows equipment 16 in track sections 100a-100d to be positioned at or between first location X and second location Y. In some embodiments, horizontal extension structure may be mounted directly to the mounting structure or gantry 14 (or truss sections 14b or other components thereof). Additionally, tracks 100 may be fastened along their length to any of the horizontal extension supports 101 that extend from the mounting structure or gantry 14 (e.g., see FIG. 14). For example, the tracks 100 may be fastened to a proximal horizontal support 101 before angled portion 98. Additionally, horizontal extension supports 101 may be positioned such that they may be attached or fastened to tracks 100 along its length. Horizontal extension supports 101 may comprise any length, width, or dimension so as to accommodate the track structure 100. As illustrated in an overhead view of the track system 10a, track structure 100 may include four (4) separate individual tracks 100a, 100b, 100c, and 100d in an exemplary embodiment. Track sections 100a-100d may be mounted such that they are positioned in front of another. In some embodiments, tracks 100a-100d may be mounted to gantry 14, or, alternatively, other structures may be used to over roadways 12, so as long as the general arrangement of tracks 100a-100d is provided as shown to position equipment 16 above lanes 13 of the roadway 12. Generally, track sections 100a-100d are designed such that they are arranged in a parallel configuration with respect to one another.

Each track section 100a-100d includes a proximal end 102 (illustrated as proximal ends 102a-102d, respectively) and a distal end 103 (illustrated as distal ends 103a-103d, respectively) (see FIG. 14). In some embodiments, the length of each track section 100a-100d (i.e. the distance between the proximal end 102 and the distal end 103 of the respective track section) may be dependent upon a location within roadway 12 for which an equipment 16 is to be positioned. That is, the length for the location of distal ends 103a-103d of each track section 100a-100d may be used as a method for determining the positioning of equipment 16 (e.g., for docking, mounting, servicing or installing). Additionally, the width or depth, height, and length of the tracks 100a-100d may be determined based on the equipment 16, transfer device 112, and/or other devices to be placed therein. For example, in some embodiments, each track section 100a-100d may include a width or depth, height, and length such as those similarly described with respect to track sections 18a-18d.

Referring to FIG. 14, for example, in some embodiments of the design, a track section assembly 100a of track structure 100 may be designed to have a longer length than that of track sections 100b-100d, such that equipment 16 is positioned over a left-most position over roadway 12 (e.g., which may correspond to, for example, a first lane 13a). In some embodiments of the design, track sections 100a-100d may be mounted to a support structure in descending order according to their lengths. However, in some embodiments, track sections 100a-100d may be mounted in ascending order to their lengths.

As noted above, track sections 100a-100d may be designed such that they generally run horizontally and in a parallel configuration with respect to one another. As also shown by FIG. 14, each track section 100a-100d may include an angled portion 98a-98d near a distal end 103a-103d thereof. Angled portions 98a-98d may be provided on each track 100a-100d so as to assist in positioning at least one equipment 16 in front of gantry 14 and aligning equipment 16 in a first position or distance D above the roadway 12. For example, equipment 16 and mounting braces 108 may be offset along the length of track structure 100 to move the equipment between locations (i.e., without the use of a displacing device such as device 80). Additionally, angled portions 98a-98d comprise an angle or bend within the horizontal plane of which tracks 100a-100d are provided. Angled portions 98a-98d may be provided such that, should equipment 16 need to be installed and/or serviced, it may be transferred or moved along one of tracks 100a-100d without interfering or damaging equipment 16 on another tracks 100a-100d.

As illustrated by the cross-sectional view in FIG. 15, a distal end 103 of each track 100 may be attached to a horizontal extension structure 101 using fasteners 101a and mounting brackets 101b. Though FIG. 15 shows track 100 mounted to an underside of horizontal extension structure 101, track 100 may be mounted to structure 101 in any number of ways and should not be limiting. Each track section 100 may be designed similar to tracks 18 described above.

Additionally, each track 100 may include at least a part of transfer device 112 for positioning equipment 16. For example, in some embodiments, transfer device 112 may include two (2) guide angles 104 and two (2) cable guides 105 to assist in transferring equipment 16 along a length of the track 100. Guide angles 104 may be fabricated with each track 100. Guide wheels 110 provided on mounting bracket 110a positioned between and supported by guide angles 104. Guide angles 104 may be provided on two sides of track 100 as shown in FIG. 15, for example, to allow guide wheels 110 to move along the length of the angles 104 (and thus, the track 100) while still maintaining contact therewith. As better shown in FIG. 16, guide wheels 110 may be vertically mounted to mounting braces 108 via mounting brackets 110a. Guide wheels 110 may be mounted to position equipment along or with respect to guide angles 104. Although two guide angles 104 are illustrated, any number of angles or devices to assist in allowing wheels 110 to move along track 100 may be used. Additionally, guide wheels 110 need not be enabled to pivot. For example, wheels 110 may be provided so as to move within a horizontal plane and not within a vertical plane, if so desired.

Cable guides 105 may be provided to accommodate or secure transfer pulley system 113 and pulley cables or cords 109 of transfer device 112. Cable guides 105 may include flanges 105a or other devices to assist in securing transfer pulley system 113 of transfer device 112 therein. Cables 109 may be used to assist in moving transfer device 112 (i.e., moving equipment 16) along the track structure 100. In some embodiments, pulley cables or cords 109 may be attached directly to mounting braces 108. For example, as shown in detail in FIG. 16, pulley cord 109 may be attached to an end using attachment pins 109a or other devices. Cables 109 may also be attached to and work in cooperation with transfer pulley system 113. Transfer pulley system 113 may assist in transferring equipment 16 along track structure 100 using guide angles 104, guide wheels 110, and rolling wheels 111, for example. Transfer pulley system 113 may include at least one wheel 113a mounted in a vertical direction on shaft 113b, and cable or cord 109 mounted in a loop around wheels 113a, for example. Transfer pulley system 113 may include at least one wheel 113a at proximal end 102 and distal end 103 of each track section 100a-100d, for example. Generally, transfer pulley system 113 may include similar features as provided above with respect to pulley system 60.

The bottom portion of each track section 100 may be in the form of flanges, for example, and may be designed to assist in holding and transferring device 108 through its associated track section (e.g. during movement). The flanges may be supports by mounting devices 100a or other means. The flanges may be designed and/or formed in any number of dimensions, so as to allow rolling wheels 111 to be positioned thereon. Rolling wheels 111 may be used to support and guide braces 108 in track 100. In an embodiment, an assembly of a plurality of wheels may be provided to assist in supporting and guiding movement of brace(s) 108 freely within track 100. In an embodiment, a plurality of rolling wheels 111 may be connected via a support frame to at least one other wheel. For example, four (4) wheels may be connected by a support frame and used to freely guide and support a brace 108.

Also, a conduit system may be provided within each track section 100a-100d for connecting to equipment 16, for example. Conduit system may include, for example, electrical wiring 106, flexible conduit 107, or other conduit components (e.g., see FIG. 15). Wiring 106 and conduit 107 generally run the length of the track 100 and may be provided in any number of locations. For example, in some embodiments, wiring 106 and conduit 107 may be provided proximal to one or more guide angles 104. In some embodiments, wiring 106 and conduit 107 may be provided or housed within guide angles 104. Additionally, in some embodiments, wiring 106 and conduit 107 may be provided within a securing device similar to device 33, and may include any number of materials. The location of wiring 106 and 107 should not be limiting.

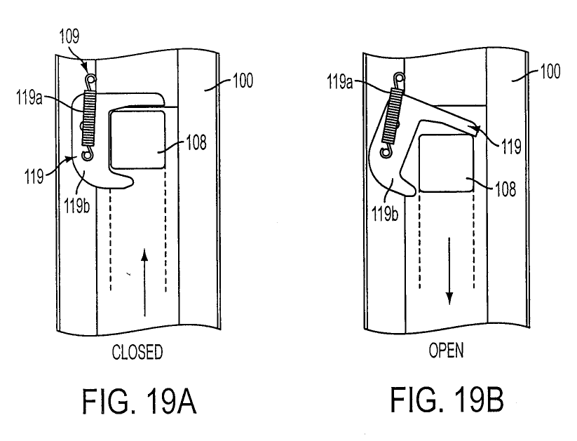

Also, referring to FIG. 16, a locking mechanism 119 may be provided for use with transfer device 112 of the track structure 100. Locking mechanism 119 may be provided to lock equipment 16, mounting braces 108, and/or wheels 110-111 in position along the length of the track structure 100. For example, locking mechanism 119 may be used to position equipment 16 at a distal end 103 of a track 100. Locking mechanism 119 may be provided to be secured and unsecured (or released) so as to limit the amount of movement of the equipment 16, braces 108, and wheels 110-111 of the transfer device 112 within the track 100, for example. Additional details with respect to locking mechanism 119 are provided below in FIGS. 19a and 19b.

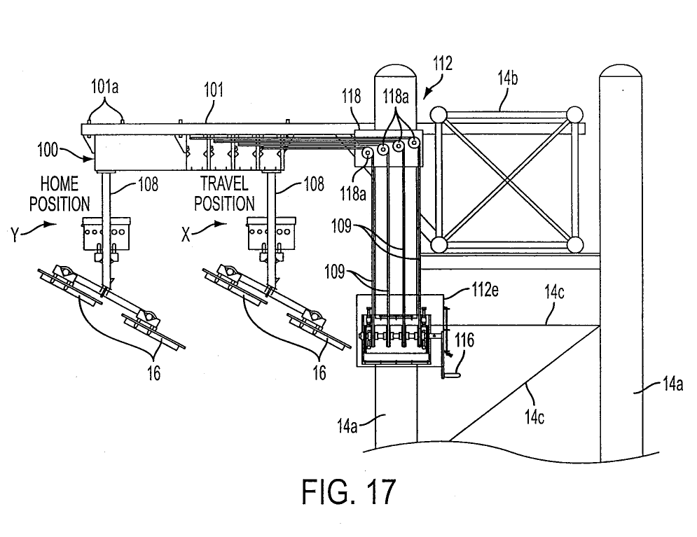

FIG. 17 illustrates transfer device 112 at a proximal end 102 of the track structure 100 in greater detail. Specifically, transfer device 112 may comprise pulley activation mechanism 112e and transfer idler pulley station 118. Transfer idler pulley station 118 is provided to direct pulley cables 109 or cords to pulley activation mechanism 112e. For example, as shown, cables 109 may be directed in a generally horizontal direction from track sections 100a-100d toward idler pulley station 118. Pulley station 118 may comprise a plurality of wheels 118a to directing each cable 109 in a generally vertical direction toward pulley activation mechanism 112a. Pulley activation mechanism 112e may be provided at a proximal end 102 of track structure 100 or on mounting structure or gantry 14. Mounting bracket 114 may be used to attach the mechanism 112e to side support 14a of gantry, for example. Pulley activation mechanism 112e may be positioned such that a worker may easily access mechanism 112e. Though pulley activation mechanism 112e is shown as being mounted near a top end of mounting structure 14, pulley activation mechanism 112e may be provided anywhere along the height of the structure 14 (e.g., closer to the roadway 12).

Also, pulley activation mechanism 112e may comprise an enclosure or cover to enclose its elements (e.g., shaft 115a, series of wheels 115c, fasteners 114a, as further described below) and/or other devices therein. For example, the enclosure may be designed such that access to the pulley activation mechanism 112e may be limited to authorized users and/or workers. In some embodiments, pulley activation mechanism 112e may be attached to mounting bracket 114 via fasteners 112a, locking bar 112b, and lock 112c. To operate transfer device 112, locking bar 112b and lock 112c of pulley activation mechanism 112e may need to be first removed, for example. Additionally, the enclosure may assist in preventing damage by persons and/or other elements, such as being exposed to the environment and weather.

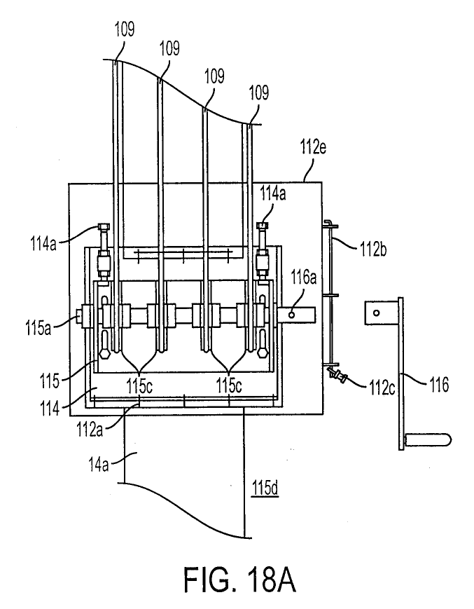

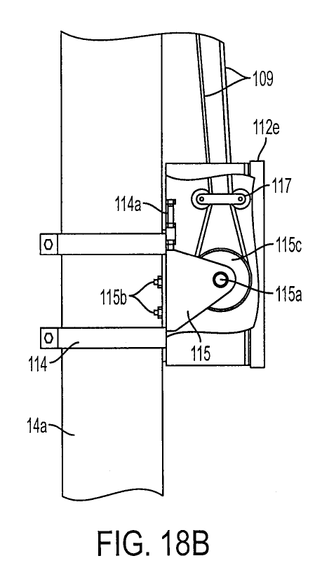

As shown in greater detail by the top and side views in FIGS. 18a and 18b, pulley activation mechanism 112e of transfer device 112 may include shaft 115a, fasteners 115b, wheels 115c, and tensioning bracket 115. A series of wheels 115c may be secured through shaft 115a along an axis. As shown, each wheel 115c may be encircled by cables or cords 109 directed from transfer pulleys 113 of each track section 100a-100d. Shaft 115a for wheels 115c may be mounted to tensioning bracket 115. Tensioning bracket 115 may be used to provide sufficient tension to cables 109 of the pulley system, for example. Tensioning bracket 115 may be secured or fastened to mounting structure or gantry 14 via fasteners 115b and mounting bracket 114. In some embodiments, mounting bracket 114 may be secured at a predetermined distance from pulley station 118 to side member 14a of gantry 14 using adjusting fasteners 114a before securing fasteners 115b of tensioning bracket 115 to the side support 14a. Fasteners 114a may be used to adjust or move bracket 115 to add or reduce tension of cables or cords 109. That is, once pulley cords 109 have been attached to wheels 115c, tensioning of cords 109 may be accomplished by loosening fasteners 115b and/or adjusting fasteners 114a, thus allowing one to move tensioning bracket 115 vertically (e.g., upwardly or downwardly) along the side support 14a until the appropriate tension of cables 109 is provided. Fasteners 115b may then be locked to mount pulley activation mechanism 112e at a determined distance.

In some embodiments, a removable crane handle 116 may be used to limit access to pulley activation mechanism 112e. For example, as an additional deterrent (i.e., in addition to locking bar 112b and lock 112c), a worker may need crane handle 116 to activate transfer device 112. Crane handle 116 may be insert onto an end of shaft 115a. Handle 116 may be secured to shaft 115a with pin 116a, for example.

In order to transfer equipment 16 associated with one track, e.g., equipment 16 of track 100a, without moving or transferring equipment 16 of another of tracks 100b-100d, Wheels 115c of the transfer device 112 may be provided in a “free” (i.e., unlocked) state with respect to shaft 115a. Thus, in order to rotate wheel(s) 115c for track 100a, a worker may be required to insert shaft key 115d into wheel 115c that is associated with the corresponding track 100a, thus determining which cable 109 and pulley 113 to activate. Also, shaft key 115d not only allows for one to initiate use of transfer device 112, but also provides additional security to accessing pulley activation mechanism 112e.

Generally, it should be noted that any number of wheels 115c may be provided. For example, the number of wheels 115c may correspond to the number of track sections 100a-100d, the number of equipment 16, or the number of lanes 13 in roadway 12. Thus, the number in the series of wheels 115c should not be limiting.

In some embodiments, additional tensioning of cables 109 or cords may be required. Thus, a floating tension device 117 may be used (see FIG. 18b). Floating tension device 117 may provide a more positive contact between cable 109 and wheel 115c. Each cable 109 may be provided with a tension device 117 so as to individually adjust a cable 109 in each track section 100a-100d. Floating tension device 117 may be provided in any position around or within pulley activation mechanism 112e. For example, floating tension device 117 may be provided at a proximate location near wheels 115c so as to allow a worker to adjust the tension of cables 109. Floating tension device 117 may comprise any number of devices for adjusting and/or limiting the tension in cables 109 and should not be limiting.

As noted above, in order to lock equipment 16 or mounting braces 18 along the track structure, locking mechanism 119 used with the transfer device 112 of the track system 10a. Locking mechanism 119 may be associated with each mounting brace 108 of each track section 100a-100d. Locking mechanism 119 may assist in stabilizing mounting braces 108 at any number of locations along a track 100, for example. Generally, any number of locking mechanisms 119 may be used.

Locking mechanism 119 may comprise a resilient device 119a and a locking bracket 119b. Resilient device 119a may comprise spring or other device, for example. Resilient device 119a may be mounted such that it assists to hold mounting braces 108 at a desired location (e.g., a second location or “home” position). Resilient device 119a may be mounted at one end to locking bracket 119b and at another end to pulley cables 109 or cords. Locking bracket 119b may be designed such that it comprises a shape similar to that of a part of mounting brace 108. For example, locking bracket 119b of locking mechanism 119 may be designed to surround an end or at least a part of mounting brace 108, shown in FIG. 16.

In order to position the equipment 16 in a location, such as a second location Y, the locking mechanism 119 is placed in a secured (closed) position and held with assistance from the tension of resilient mechanism 119a. Resilient device 119a may hold braces 108 until released by pressure or force. When it is needed to move equipment 16 and/or mounting braces 108, pressure or force may be applied to release locking mechanism 119 from its secured position. For example, in an embodiment, resilient device 119a may be released by the activation of the transfer device 112. In an embodiment, for example, a significant amount of pressure may be applied to release resilient mechanism 119a by way of tensioning pulley cord 109 through pulley activation mechanism 112e, thus releasing tension on spring 119a allowing locking mechanism 119 to be removed from surrounding an end of mounting brace 108 and open to an unsecured position. Thus, mounting braces 108 are released for movement along the associated track section 100. In some embodiments, locking mechanism 119 may remain in the open position until the equipment 16/mounting brace 108 is transferred back to a distal end 103 of the associated track.

While the principles of the invention have been made clear in the illustrative embodiments set forth above, it will be apparent to those skilled in the art that various modifications may be made to the structure, arrangement, proportion, elements, materials, and components used in the practice of the invention.

It will thus be seen that the features and advantages of this invention have been fully and effectively accomplished. It will be realized, however, that the foregoing preferred specific embodiments have been illustrated and described for the purpose of illustrating the functional and structural principles of this invention and are subject to change without departure from such principles. Therefore, this invention includes all modifications encompassed within the spirit and scope of the following claims.

What is claimed is:

1. A system for mounting at least one equipment over a roadway, the at least one equipment for collecting information from vehicles moving through at least one lane on the roadway, the system comprising:
a mounting structure adapted to support the at least one equipment over the at least one lane on the roadway;
at least one track coupled to the mounting structure;
a transfer device movably disposed in the at least one track between a first location and a second location along the at least one track, the transfer device adapted to mount the at least one equipment;
whereby the at least one equipment mounted to the transfer device is adapted to be moved from the first location to the second location via the transfer device along the at least one track.

2. The system of claim 1, wherein the first location corresponds to location proximate a distal end of the at least one track.

3. The system of claim 1, wherein the first location corresponds to a location over the at least one lane.

4. The system of claim 1, wherein the first location comprises a predetermined dimension, the predetermined dimension including a distance with respect to the roadway or an angle with respect to the mounting structure.

5. The system of claim 1, wherein the second location corresponds to a location proximate a proximal end of the at least one track.

6. The system of claim 1, wherein the second location corresponds to a location adjacent to but not over the roadway.

7. The system of claim 1, wherein the mounting structure compnses a gantry.

8. The system of claim 1, wherein the mounting structure is attached to an existing structure.

9. The system of claim 1, wherein the transfer device further comprises a pulley system.

10. The system of claim 1, further comprising:
a displacing device for moving the at least one equipment from a first position relative to the at least one track to a second position relative to the at least one track.

11. The system of claim 9, wherein the displacing device further comprises a resilient mechanism to assist in moving the at least one equipment.

12. The system of claim 4, wherein the at least one track comprises an angled section to assist in positioning the at least one equipment in the first position when moving the at least one equipment from the first location to the second location.

13. The system of claim 11, wherein the transfer device comprises a pulley system.

14. A method for accessing at least one equipment mounted on a mounting structure above a series of lanes of a roadway, the method comprising:
transferring, via a transfer device, the at least one equipment from a first location to a second location along the mounting structure, the transfer device movably disposed in at least one track provided on the mounting structure, the at least one equipment mounted to the transfer device;
moving, via a displacing device, the at least one equipment from a first position relative to the at least one track to a second position relative to the at least one track.

15. A system for mounting a plurality of equipment over a roadway, each of the plurality of equipment for collecting information from vehicles moving through at least one lane on the roadway, the system comprising:
a mounting structure adapted to support the plurality of equipment over the at least one lane on the roadway;
a plurality of tracks, each of the plurality of tracks coupled to the mounting structure;
a plurality of transfer devices, at least one of the plurality of transfer devices movably disposed in each of the plurality of tracks, each of the plurality of transfer devices adapted to move in a corresponding one of the plurality of tracks between a first location and a second location along the corresponding one of the plurality of tracks, each of the plurality of transfer devices adapted to mount at least one of the plurality of equipment;
whereby the at least one of the plurality of equipment mounted to one of the plurality of the transfer devices is adapted to be moved from the first location to the second location via the one of the plurality of transfer devices along the corresponding one of the plurality of tracks.

16. The system of claim 14, further comprising:
a pulley system disposed in each of the plurality of tracks for moving a corresponding one of the plurality of transfer devices along the mounting structure.

17. The system of claim 14, further comprising:
a displacing device operating in conjunction with each of the plurality of tracks for moving a corresponding one of the plurality of equipment from a first position relative to said each of the plurality of tracks to a second position relative to said each of the plurality of tracks.

18. The system of claim 14, wherein the plurality of tracks are aligned in a horizontal and parallel configuration, and, wherein, the plurality of tracks further comprise angled sections so as to position a corresponding one of the plurality of equipment in a position relative to each of the plurality of tracks.

19. A track system for positioning at least one equipment near a roadway, the at least one equipment for collecting information from vehicles moving through at least one lane on the roadway, the system comprising:
at least one track structure positioned over the at least one lane on the roadway;
a transfer device movably disposed in the at least one track between a first location and a second location along the at least one track structure, the at least one equipment mounted to the transfer device;
whereby the at least one equipment mounted to the transfer device is adapted to be moved from the first location to the second location via the transfer device along the at least one track structure.

20. The system of claim 18, wherein the at least one track structure further comprises at least one channel for accommodating the transfer device.

21. The system of claim 18, further comprising:
a conduit system for capturing cables or wiring within the at least one track structure.

22. The system of claim 18, further comprising:
a pulley system disposed in the at least one track structure for moving the at least one transfer device along the at least one track structure.

23. The system of claim 18, further comprising:
a mounting structure adapted to support the at least one track structure and the at least one equipment over the at least one lane on the roadway.

24. The system of claim 18, further comprising:
a displacing device operating in conjunction the at least one track structure for moving a corresponding equipment from a first position relative to the at least one track structure to a second position relative to the at least one track structure.
